(19) United States
(12) Patent Application Publication
(10) Pub. No.: US 2005/0128761 A1
(43) Pub. Date: Jun. 16, 2005

(54) Turn signal light using light-emitting diodes as light sources

(76) Inventor: Shih-Hsiung Wu, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/731,014

(22) Filed: Dec. 10, 2003

(51) Int. Cl. B60Q 1/56

(52) U.S. Cl. 362/498; 362/540; 362/800; 362/543; 362/545

(57) ABSTRACT

A turn signal light includes a circuit board, on which a plurality of light-emitting diodes are mounted to serve as light sources of the turn signal light, and an intermediate board located in front of the circuit board and provided with a plurality of reducing openings to each enclose one light-emitting diode, and a lens provided at an inner side with a plurality of raised areas. Light beams emitted from the light-emitting diodes are reflected at the reducing openings and refracted by the raised areas of the lens to provide diffused light and enhanced illuminating effect.

### FIELD OF THE INVENTION

The present invention relates to a turn signal light, and more particularly to a turn signal light that uses light-emitting diodes as light sources.

### BACKGROUND OF THE INVENTION

A turn signal light is provided to warn other drivers or pedestrians of a car going to turn or change its moving direction. Generally, the turn signal light for a vehicle uses a tungsten lamp as a light source. However, the conventional tungsten lamp tends to burn out due to high temperature or break due to shocks. And, light beams emitted from the tungsten lamp are too sharp. With advancements in the scientific field, light-emitting diode (LED) has been developed. An LED has the advantages of providing a radiated light source and moderate beams, and not tending to break due to shocks, and is therefore gradually adopted by consumers as a light source of the turn signal light. Nevertheless, light beams emitted from the LED are projected in the manner of bunched beams and thus provide a relatively small halo effect surrounding the turn signal light, which is not easily perceived by a driver of a coming car and therefore not safe for use.

### SUMMARY OF THE INVENTION

A primary object of the present invention is to provide an improved turn signal light using light-emitting diodes as light sources, in which part of direct light beams emitted from light-emitting diodes are reflected and refracted to produce even better illuminating and warning effect.

To achieve the above and other objects, the turn signal light using light-emitting diodes as light sources according to the present invention mainly includes a backboard; a circuit board located in front of the backboard and provided at a front side with a plurality of light-emitting diodes to serve as light sources of the turn signal light; an intermediate board located in front of the circuit board and provided with a plurality of reflecting openings having reducing cross section to each enclose one light-emitting diode; and a lens located in front of the intermediate board and provided at an inner side with a plurality of raised areas. Part of initially direct light beams emitted from the light-emitting diodes are reflected at the reducing openings and refracted by the raised areas of the lens to provide diffused light and enhanced illuminating effect.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a turn signal light using light-emitting diodes as light sources according to an embodiment of the present invention;

FIG. 2 is an assembled top perspective view of FIG. 1;

FIG. 3 is a bottom perspective view of a lens of the turn signal light of FIG. 1;

FIG. 4 is an assembled sectional view of FIG. 2;

FIG. 5 is a sectional view showing the illuminating effect of the present invention;

FIG. 6 shows the use of the present invention on a motorcycle;

FIG. 7 shows the use of the present invention on a car; and

FIG. 8 is a bottom perspective view of an intermediate board in the turn signal light of the present invention.

### DETAILED DESCRIPTION OF THE PREFERRED EMBODIMENTS

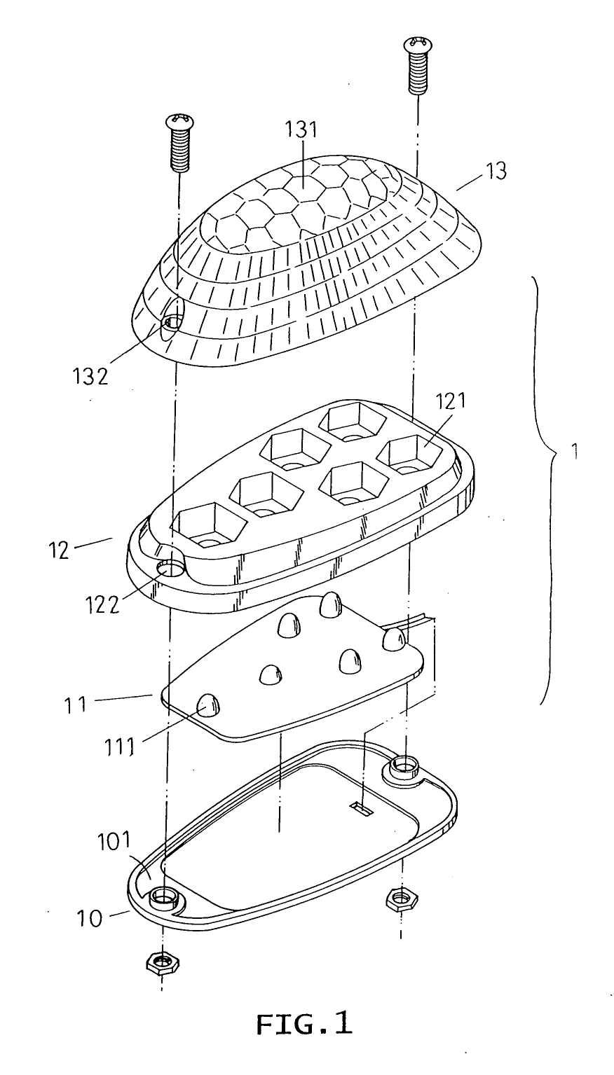

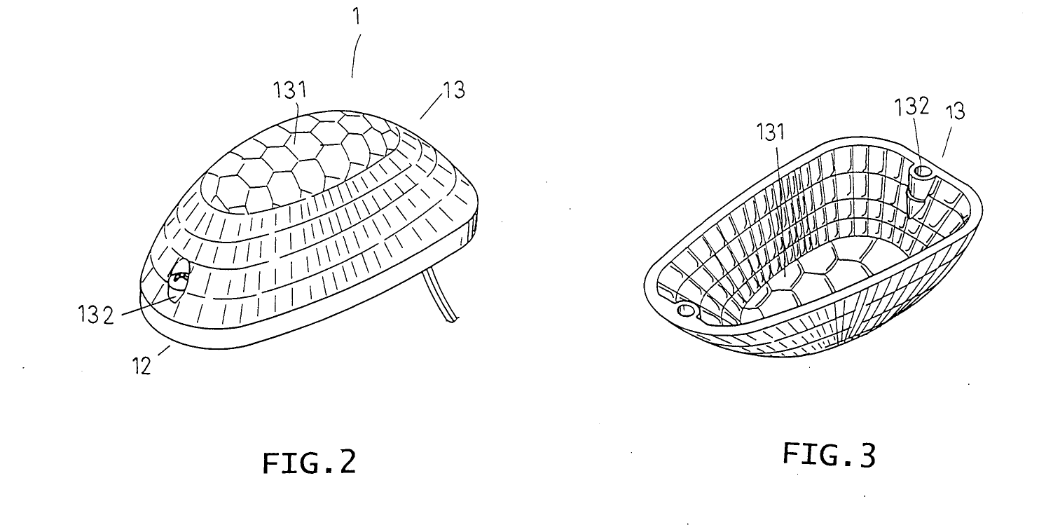

Please refer to FIG. 1 that is an exploded perspective view of a turn signal light 1 using light-emitting diodes as light sources according to the present invention. As shown, the turn signal light 1 mainly includes from bottom to top a backboard 10, a circuit board 11, an intermediate board 12, and a lens 13. FIG. 2 is an assembled perspective view of FIG. 1.

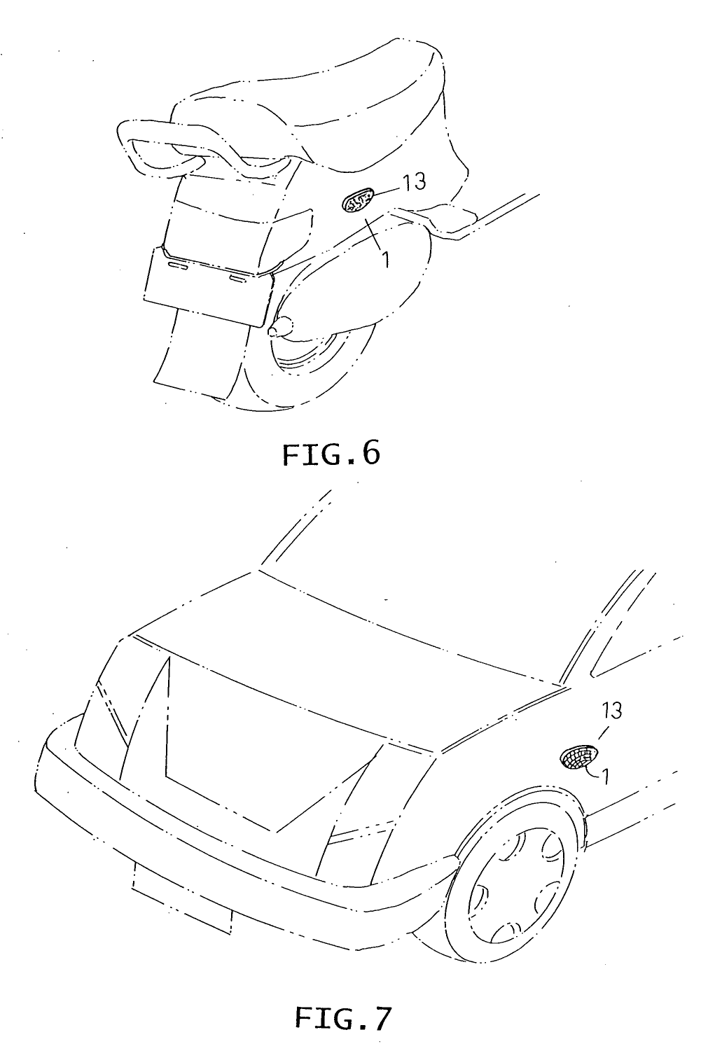

The backboard 10 is a member having a flat rear side adapted for fitly attaching to any desired position on a vehicle, such as a motorcycle as shown in FIG. 6, or a car as shown in FIG. 7. Mounting holes 101 are provided on the backboard 10 at predetermined positions.

The circuit board 11 is provided on front and rear sides with a plurality of circuit elements (not shown), and at the front side with a plurality of light-emitting diodes 111.

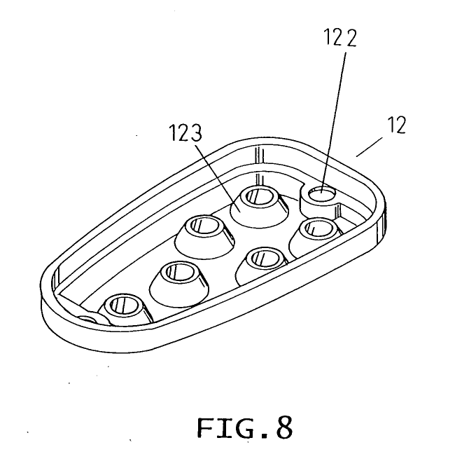

The intermediate board 12 is located between the circuit board 11 and the lens 13, and provided with a plurality of separated openings 121 corresponding to the light-emitting diodes 111 on the circuit board 11. Each of the openings 121 has a reducing cross section from outer to inner end thereof. Please refer to FIG. 8. An inner portion of each opening 121 located behind the intermediate board 12 forms a rearward protruded protective wall 123 to protect a corresponding light-emitting diode 111. Spaces on a rear side of the intermediate board 12 between the protective walls 123 may still be fully utilized to accommodate electronic elements.

In the illustrated embodiment, each of the openings 121 has a hexagonal cross section. Through holes 122 are provided on the intermediate board 12 corresponding to the mounting holes 101 on the backboard 10. When the intermediate board 12 is connected to the front side of the backboard 10 to locate in front of the circuit board 11, the light-emitting diodes 111 are separately enclosed in inner surfaces of the openings 121 and the protective walls 123. The intermediate board 12 may have a outer surface made of a reflecting material to enables the turn signal light of the present invention to have an enhanced illuminating effect.

Please refer to FIGS. 2 and 3. The lens 13 is provided at an inner side with a plurality of raised areas 131. The raised areas 131 are not limited to any specific shape or type, and number. Mounting holes 132 are provided on the lens 13 corresponding to the mounting holes 101 on the backboard 10.

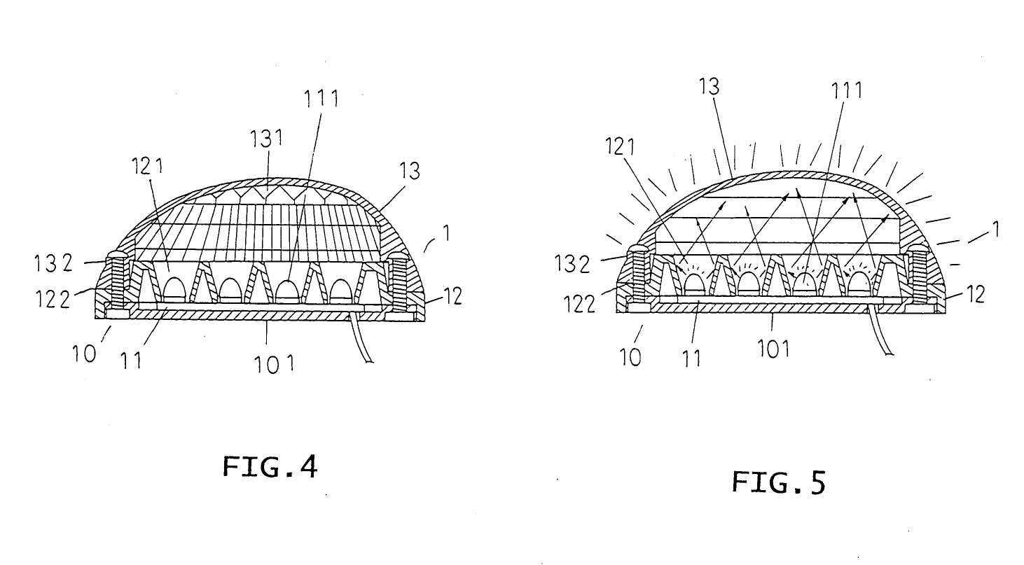

FIG. 4 is an assembled sectional view of the turn signal light 1 of the present invention.

Please refer to FIG. 5. Light beams emitted from the light-emitting diodes 111 are first reflected at the inner wall surfaces of the openings 121 to intersect with one another. When the intermediate board 12 has reflecting outer surfaces, the reflection effect would be even better. The reflected light beams are then projected toward the inner side of the lens 13 and refracted by the raised areas 131 to shine in all directions.

The following are some advantages of the present invention:

1. The initially direct light beams emitted from the light-emitting diodes 111 enclosed in the openings 121 are reflected at the reflecting inner wall surfaces of the openings 121 to intersect with one another.

2. The openings 121 with reducing cross section and the protective walls 123 behind the intermediate board 12 provide good protection to the light-emitting diodes 111, and the spaces between the protective walls 123 may still be fully utilized to accommodate electronic elements.

3. The raised areas 131 provided at the inner side of the lens 13 provide good refraction effect for the light beams emitted from the light-emitting diodes 111 to spread over an even wider range, enabling the turn signal light to be viewed by other drivers and pedestrians from widened viewing angles.

The present invention has been described with a preferred embodiment thereof and it is understood that many changes and modifications in the described embodiment can be carried out without departing from the scope and the spirit of the invention that is to be limited only by the appended claims.

1. A turn signal light using light-emitting diodes as light sources, comprising a backboard, a circuit board, an intermediate board, and a lens;
said backboard being a member having a flat rear side adapted for fitly attaching to any desired position on a vehicle, and mounting holes being provided on said backboard at predetermined positions;
said circuit board being located at a front side of said backboard, and being provided at a front side with a plurality of light-emitting diodes;
said intermediate board being located between said circuit board and said lens, and provided with a plurality of separated openings having reflecting inner surfaces and corresponding to said light-emitting diodes on said circuit board, so as to separately enclose one corresponding light-emitting diode; and through holes being provided on said intermediate board corresponding to said mounting holes on said backboard; and
said lens being provided at an inner side with a plurality of raised areas, and mounting holes being provided on said lens corresponding to said mounting holes on said backboard;
whereby when said lens, said intermediate board, said circuit board, and said backboard are sequentially assembled from top to bottom to form said turn signal light, part of initially direct light beams emitted from said light-emitting diodes are reflected at said reflecting inner surfaces of said openings and refracted by said raised areas at inner side of said lens, producing a light diffusing effect for said turn signal light to be more easily viewed from different angles.

2. The turn signal light using light-emitting diodes as light sources as claimed in claim 1, wherein each of said openings has a hexagonal cross section.

3. The turn signal light using light-emitting diodes as light sources as claimed in claim 1, wherein each of said openings has a reducing cross section from outer to inner end thereof.

4. The turn signal light using light-emitting diodes as light sources as claimed in claim 1, wherein each of said openings has an inner portion rearward protruded beyond said intermediate board to provide a reflecting protective wall surrounding one said light-emitting diode.
